(19) United States
(12) Patent Application Publication
(10) Pub. No.: US 2026/0084445 A1
(43) Pub. Date: Mar. 26, 2026

(54) EDGE PORTION DETECTION METHOD AND LIQUID EJECTION APPARATUS

(71) Applicant: CANON KABUSHIKI KAISHA, Tokyo (JP)

(72) Inventors: Kenji Kubozono, Tokyo (JP); Keita Tamiya, Kanagawa (JP)

(21) Appl. No.: 19/332,233

(22) Filed: Sep. 18, 2025

(30) Foreign Application Priority Data
Sep. 20, 2024 (JP) 2024-163983

(51) Int. Cl. B41J 11/00; B41J 25/00

(52) U.S. Cl. CPC B41J 11/0095; B41J 11/008; B41J 25/001

(57) ABSTRACT

A technique for detecting a medium's edge portion with high accuracy is provided. To this end, a liquid ejection apparatus adjusts a differential output by having a plurality of light reception units, obtaining a differential output based on outputs from the plurality of light reception units, and adjusting the light reception sensitivity of the light reception units using an adjustment unit.

### BACKGROUND

### Field of the Technology

The present disclosure relates to an edge portion detection method and a liquid ejection apparatus.

### Description of Related Art

In performing borderless printing with an inkjet printing apparatus, the printing apparatus typically performs the printing while detecting the edge portions of a printing medium.

Japanese Patent Laid-Open No. 2004-182361 proposes a method for detecting an edge portion of a medium using an optical sensor including a pair of a light-emitting device and a light receiving device.

However, in a case where a conventional optical sensor is used to detect a printing medium, an output voltage may vary depending on environmental fluctuations occurring during a scan of the medium, such as, for example, lifting of the medium's edge portion or outside light. This leads to a problem where the edge portion of the medium cannot be detected with high accuracy.

### SUMMARY

To this end, an edge portion detection method of the present invention is an edge portion detection method for detecting an edge portion of a sheet in terms of a width direction of the sheet using a detection unit provided to a carriage movable in the width direction of the sheet. The detection unit has a light emission unit, a light reception unit including a first light reception unit including a plurality of light-receiving devices configured to receive light emitted from the light emission unit and then reflected and a second light reception unit disposed at a position away from the first light reception unit in the width direction and including a plurality of light-receiving devices configured to receive light emitted from the light emission unit and then reflected, and a differential amplification circuit unit configured to amplify a difference between an output signal from the first light reception unit and an output signal from the second light reception unit. The method has an adjustment step of adjusting a differential output from the differential amplification circuit unit; an obtainment step of, while moving the carriage, obtaining a differential output from the differential amplification circuit unit adjusted in the adjustment step; and a detection step of detecting an edge portion of the sheet based on a change in the differential output relative to a position of the carriage obtained in the obtainment step.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing the outer appearance of a liquid ejection apparatus.

FIG. 2 is a block diagram of a control unit of the liquid ejection apparatus.

FIGS. 3A and 3B are diagrams showing a hardware configuration of the liquid ejection apparatus.

FIGS. 4A and 4B are diagrams showing a concept of a printing medium edge portion detection operation by the liquid ejection apparatus.

FIGS. 5A and 5B are diagrams conceptually showing an adjustment operation.

FIG. 6 is a flowchart showing a printing process.

FIG. 7 is a diagram showing a method for adjusting the light reception sensitivity of a light reception unit.

FIG. 8 is a diagram showing a method for adjusting an amplification factor of a differential amplification circuit of the light reception unit.

FIG. 9 is a diagram showing a method of current adjustment by a light emission amount adjustment circuit of a light emission unit.

### DESCRIPTION OF THE EMBODIMENTS

### First Embodiment

A first embodiment of the present invention is described below with reference to the drawings.

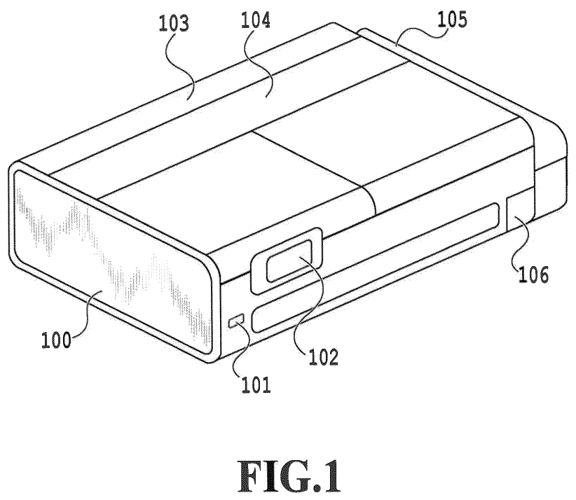

FIG. 1 is a perspective view showing the outer appearance of a liquid ejection apparatus 100 according to the present embodiment. The liquid ejection apparatus 100 is an inkjet printing apparatus that prints an image on a sheet by alternately repeating a print operation of ejecting a liquid ink from a moving liquid ejection head and a conveyance operation of conveying the printing medium. However, besides an inkjet printing apparatus, the present invention can be applied to various other liquid ejection apparatuses as well.

Note that “printing” includes not only forming meaningful information such as characters or shapes, but also, in a broader sense, forming an image, a design, or a pattern on a printing medium or processing a medium, irrespective of it being meaningful or meaningless. It does not matter whether what is printed is manifested to be visually perceivable by humans. Also, although a sheet of paper is assumed as a “printing medium”in the present embodiment, a cloth, a plastic film, or the like may be used.

The liquid ejection apparatus 100 has a flat, cuboid external shape as a whole and includes a cut paper feed unit 104 and a roll paper feed unit 103 to set a printing medium, an ink supply unit 105 configured to supply ink, and a waste liquid tank unit 106 to which to insert a waste liquid tank.

The liquid ejection apparatus 100 is provided with an operation unit 102 configured to receive operations by an operator. The operation unit 102 includes a touch panel display unit and is configured to receive input operations by an operator and display information to the operator. The liquid ejection apparatus 100 also includes a notification unit 101 and can provide a sound notification in response to an operation performed on each unit.

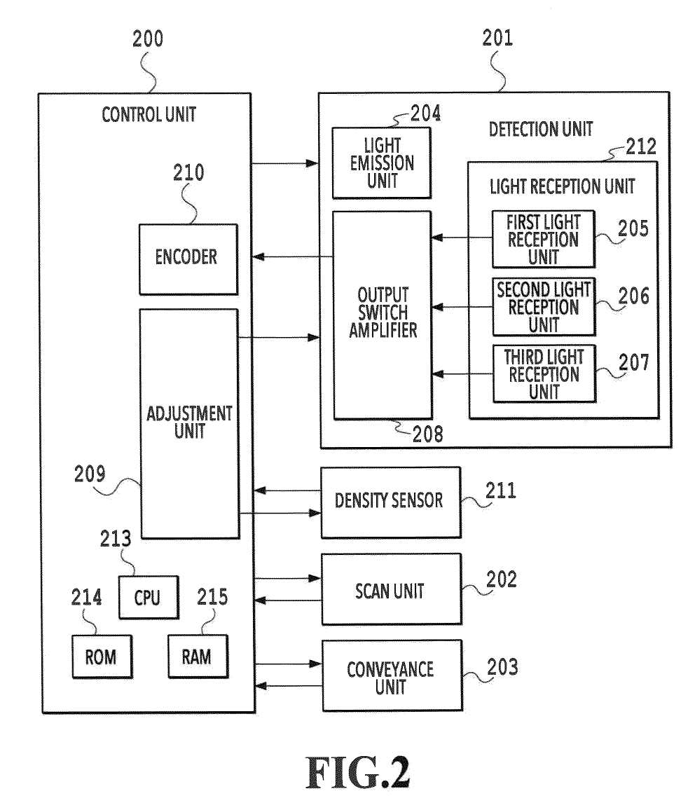

FIG. 2 is a block diagram of a control unit of the liquid ejection apparatus 100. A control unit 200 has a CPU 213, ROM 214, RAM 215, an adjustment unit 209, and an encoder 210. The control unit 200 moves a detection unit 201 to a position above an edge portion of a printing medium using a scan unit 202. With the detection unit 201 above an edge portion of a printing medium, the control unit 200 lights up a light emission unit 204 of the detection unit 201, thereby applying light to the printing medium. Light reflected by the printing medium is received by a first light reception unit 205, a second light reception unit 206, or a third light reception unit 207, and an output signal is outputted to the control unit 200 via an output switch amplifier (differential amplification circuit unit) 208. Using the adjustment unit 209, the control unit 200 adjusts an output signal from the detection unit 201 and an output signal from a density sensor 211 to a signal level suitable for printing medium edge portion detection. After the adjustment, the control unit 200 moves the detection unit 201 from a position above the printing medium to an edge portion using the scan unit 202, and based on an output signal obtained, the encoder 210 obtains the coordinates of the position of the printing medium edge portion.

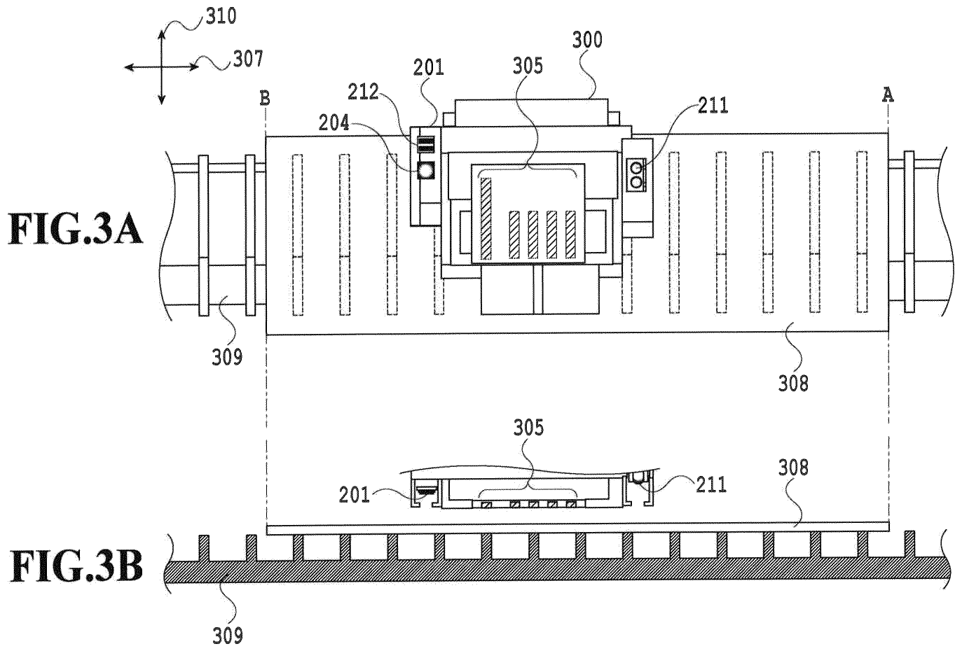

FIGS. 3A and 3B are diagrams showing a hardware configuration of the liquid ejection apparatus 100. The liquid ejection apparatus 100 includes a carriage 300 movable in directions along the width of a printing medium. The liquid ejection apparatus 100 scans the carriage 300 in a scan direction 307, the carriage 300 carrying the detection unit 201 having a light reception unit 212 and the light emission unit (LED light source) 204, the density sensor 211, and a group of nozzles 305. Also, the liquid ejection apparatus 100 conveys a printing medium 308 in a conveyance direction 310 on a platen 309. The scan direction 307 and the conveyance direction intersect with each other. The detection unit 201 is provided at one of the end portions of the carriage 300 in terms of the scan direction and detects the position of an edge portion A of the printing medium 308, an edge portion B of the printing medium 308, or the leading edge portion of the printing medium 308 in terms of the conveyance direction. The density sensor 211 is provided at the other end portion of the carriage 300 in terms of the scan direction and can perform density detection on the printing medium 308.

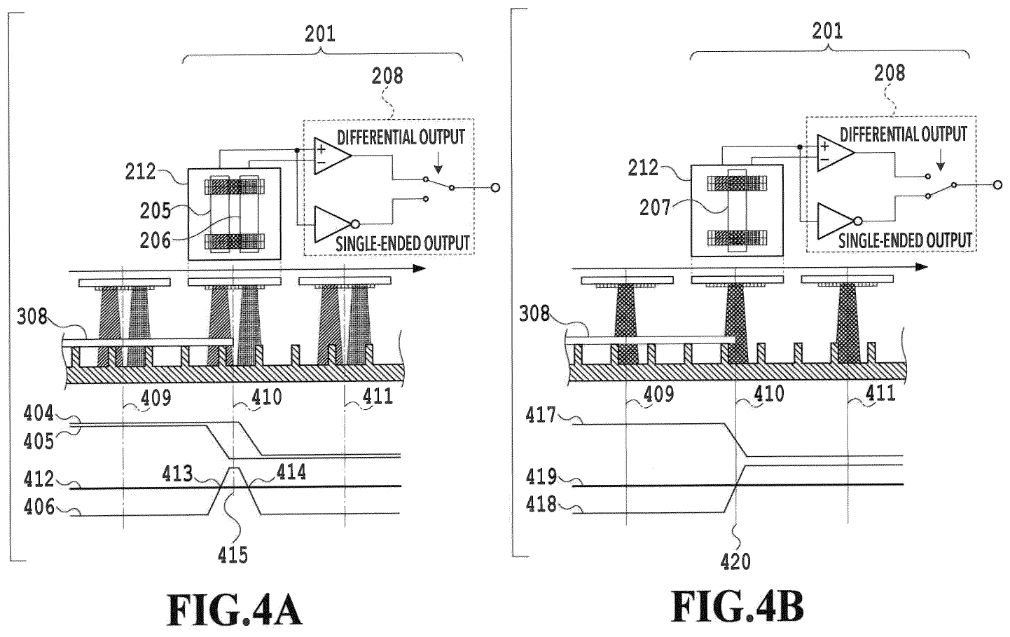

FIGS. 4A and 4B are diagrams showing a concept of a printing medium edge portion detection operation by the liquid ejection apparatus 100. The light emission unit 204 is omitted here. The light reception unit 212 of the detection unit 201 includes the first light reception unit 205, the second light reception unit 206, and the third light reception unit 207. An output voltage 404 from the first light reception unit 205, an output voltage 405 from the second light reception unit 206, and an output voltage 417 from the third light reception unit 207 are inputted to the output switch amplifier 208. The control unit 200 can switch an output mode between a differential mode and a single-ended mode. FIG. 4A shows detection in the differential mode, and FIG. 4B shows detection in the single-ended mode (a first operation mode). In the single-ended mode, the signal level of an output signal (a single-ended output signal) is determined by the output voltage 417 from the third light reception unit 207 in reference to the ground (0 V). Meanwhile, in the differential mode (a second operation mode), the potential difference between the output voltage 404 from the first light reception unit 205 and the output voltage 405 from the second light reception unit 206 is the signal level of a single output signal (a differential output signal).

In a case where the output switch amplifier 208 is set to the differential mode, a differential output 406 is outputted as the detection unit 201 is moved above the printing medium 308 in a scan direction 407 (see FIG. 4A). In the differential mode, the differential output 406 is outputted based on the output voltage 404 from the first light reception unit 205 and the output voltage 405 from the second light reception unit 206.

At a position 409 where the detection unit 201 is disposed above the printing medium 308, the output voltage 404 from the first light reception unit 205 and the output voltage 405 from the second light reception unit 206 are both high (H) (i.e., there is no difference); therefore, the differential output 406 is low (L). At a position 410 where the detection unit 201 is disposed above an edge portion of the printing medium 308, the output voltage 404 from the first light reception unit 205 is high (H), and the output voltage 405 from the second light reception unit 206 is low (L) (i.e., there is a difference); therefore, the differential output 406 is high (H). At a position 411 where the detection unit 201 is not disposed above the printing medium 308, the output voltage 404 from the first light reception unit 205 and the output voltage 405 from the second light reception unit 206 are both low (L) (i.e., there is no difference); therefore, the differential output 406 is low (L).

Thus, with a predetermined threshold voltage 412 being set for a change in the differential output 406, a position 413 where the differential output 406 exceeds the threshold voltage 412 and a position 414 where the differential output 406 falls below the threshold voltage 412 are detected, and a middle point 415 between the position 413 and the position 414 is detected as the position of an edge portion of the printing medium 308.

In a case where the output switch amplifier 208 is set to the single-ended mode, a single ended output 418 is outputted while the detection unit 201 is moved in the scan direction 407 above the printing medium 308 (see FIG. 4B). In the single-ended mode, the single-ended output 418 inverted from the output voltage 417 from the third light reception unit 207 is outputted. At the position 409 where the detection unit 201 is disposed above the printing medium 308, an output 417 from the third light reception unit 207 is high (H); thus, the single-ended output 418 is low (L). At the position 410 where the detection unit 201 is disposed above an edge portion of the printing medium 308, the output 417 from the third light reception unit 207 changes, which changes the single-ended output 418 as well. At the position 411 where the detection unit 201 is not disposed above the printing medium 308, the output 417 from the third light reception unit 207 is low; thus, the single-ended output 418 is high.

Thus, with a threshold voltage 419 set for a change in the single-ended output 418, a position 420 where the single-ended output 418 exceeds the threshold voltage 419 is detected, and the position 420 is detected as the position of an edge portion.

In a case of detection in the differential mode, the voltage levels of the output voltage 404 from the first light reception unit 205 and the output voltage 405 from the second light reception unit 206 may become low as a whole due to manufacturing variance and variance of the reflection characteristics of a scan target. In this case, between scanning the printing medium 308 and scanning the platen 309, a difference in voltage level is small, and thus the voltage level of the differential output 406 is also low. As a result, the differential output 406 may fail to exceed the threshold voltage 412 or may exceed the threshold voltage 412 only by a very small value, which may hinder accurate detection of the position of an edge portion of the printing medium 308 based on the middle point 415.

Thus, before performing the detection of an edge portion in the differential mode, the present embodiment performs output adjustment in the single-ended mode and adjusts the differential output by moving a sensor based on the result of the position detection of a paper edge portion in the single-ended mode. The following describes how this is done.

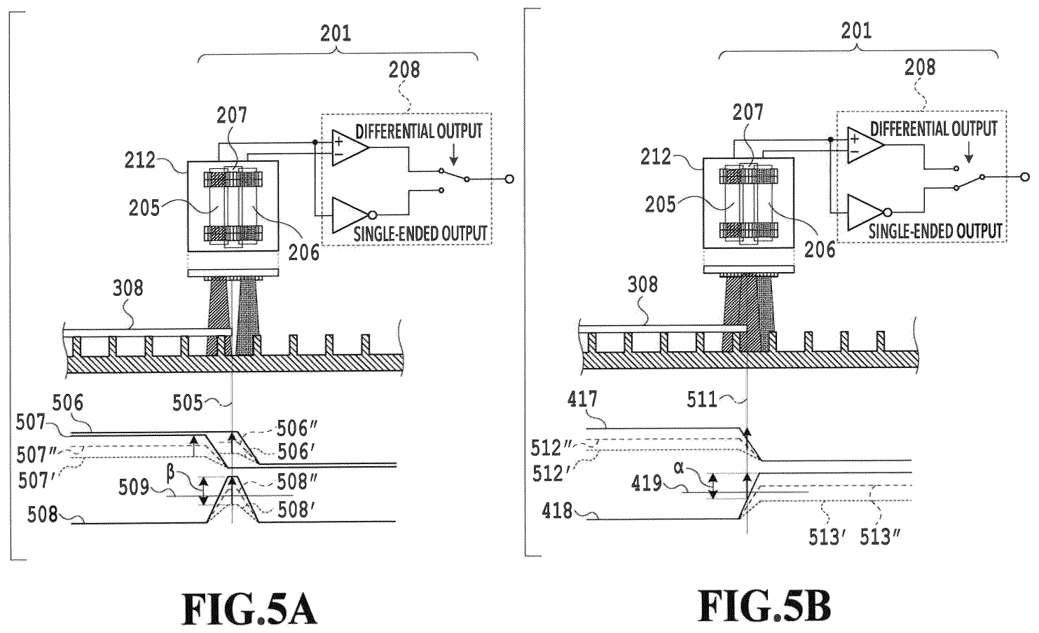

FIGS. 5A and 5B are diagrams conceptually showing an adjustment operation in the present embodiment. FIG. 5A shows adjustment in the differential mode, and FIG. 5B shows adjustment in the single-ended mode.

In the single-ended mode, with the light emission unit 204 (not shown in FIGS. 5A and 5B) being lit up to apply light to a printing medium, the third light reception unit 207 receives light reflected by the printing medium and a platen 306 while the carriage is moved. In this event, in a case where the printing medium is one with a low reflectivity, as the output voltage from the third light reception unit 207, an output voltage 512′ changes from a relatively low high (H) level to a low (L) level, and as the single-ended output, a single-ended output 513′changes from a low (L) level to a relatively low high (H) level. In such a case, the adjustment unit 209 (see FIG. 2) performs sensitivity adjustment. Specifically, the sensitivity of the third light reception unit 207 is adjusted so that the high level (H) of the single-ended output may become a value exceeding the threshold voltage 419 and almost twice as high as the original single-ended output 513′. The symbol α shown in FIG. 5B represents a correction amount for the single-ended output.

Then, the sensitivities of the first light reception unit 205 and the second light reception unit 206 are adjusted based on the sensitivity adjustment of the third light reception unit 207 to correct the differential output. In a case of a printing medium with a low reflectivity, the first light reception unit 205 outputs an output voltage 506′or 506″, and the second light reception unit 206 outputs an output voltage 507′or 507″. As the differential output, a differential output 508′or 508″ is outputted. Also, in a case of an ideal printing medium, the first light reception unit 205 outputs an output voltage 506, and the second light reception unit 206 outputs an output voltage 507. As the differential output, a differential output 508 is outputted. Thus, correction is made so that an output voltage in a case of a printing medium with a low reflectivity will be an output voltage in a case of an ideal printing medium. A threshold 509 is set as a threshold, and the sensitivities are adjusted so that the differential output will be a value which is about twice as high as the threshold 509. The symbol β shown in FIG. 5A is a correction amount for the differential output.

In this way, the sensitivity of the third light reception unit 207 is adjusted in advance, and the sensitivities of the first light reception unit 205 and the second light reception unit 206 are adjusted according to the adjusted sensitivity of the third light reception unit 207. This enables detection with high accuracy in the differential mode. Although the sensitivity of the light reception unit is adjusted above, it is to be noted that it is also possible to adjust the amount of light emitted by the light emission unit 204 or to adjust the amplification factor of the output switch amplifier 208.

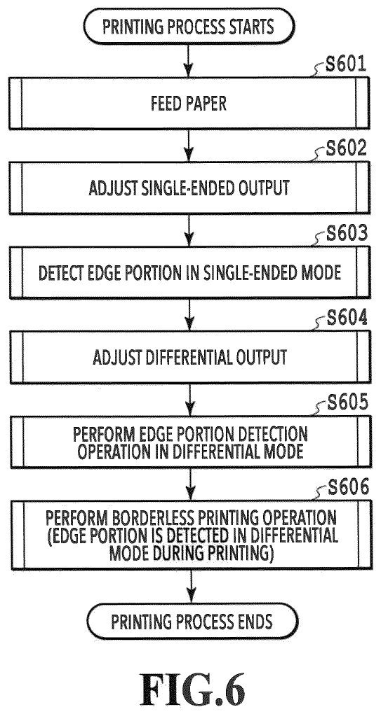

FIG. 6 is a flowchart showing a printing process in the present embodiment. The series of processes shown in FIG. 6 is executed by the CPU 213 of the liquid ejection apparatus 100 by loading program code stored in the ROM 214 into the RAM 215 and executing the program code. Alternatively, some or all of the functions in the steps in FIG. 6 may be implemented by hardware such as an application-specific integrated circuit (ASIC) or an electric circuit. Note that the symbol “S” in the description of each process means that it is a step in the flowchart. A printing process in the present embodiment is described below using the flowchart in FIG. 6.

Once a printing process is started in response to a print instruction, in S601 the CPU 213 performs paper feed to convey a printing medium to a print unit. In S602, the CPU 213 applies light to the printing medium being fed, and adjusts the single-ended output based on the reflected light. In S603, the CPU 213 performs edge portion detection in the single-ended mode on an edge portion of the printing medium with the single-ended output adjusted. In S604, the CPU 213 performs differential output adjustment based on the edge portion position identified based on the single ended output. In S605, the CPU 213 detects an edge portion of the printing medium in the differential mode. In S606, the CPU 213 starts printing on the printing medium based on the edge portion position information obtained in S605. Specifically, while detecting an edge portion of the printing medium in the differential mode with the differential output adjusted, the CPU 213 adjusts print positions according to the fluctuations in the edge portion position detected. Once all the print scans are finished, the present process ends.

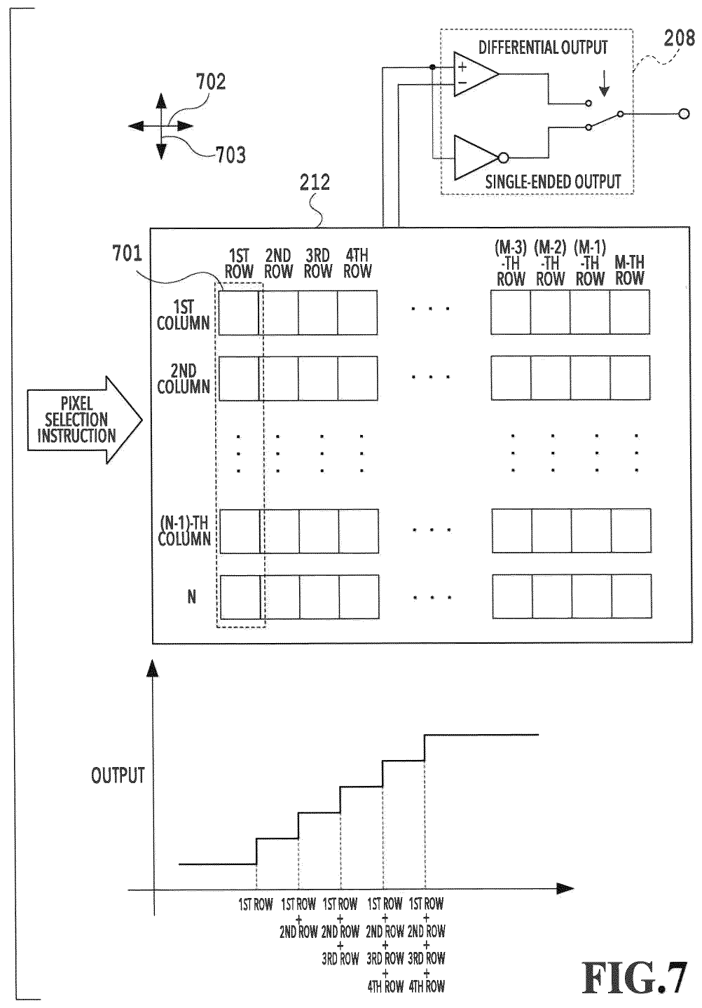

FIG. 7 is a diagram showing a method for adjusting the light reception sensitivity of the light reception unit 212. As an example of sensitivity adjustment in the present embodiment, the following describes a method for adjusting the light reception sensitivity of the light reception unit. Note that the first light reception unit 205, the second light reception unit 206, and the third light reception unit 207 each form part of the light reception unit 212.

The light reception unit 212 has a plurality of light-receiving devices 701, and the light receiving devices 701 are arrayed two dimensionally in a direction 702 in which the light reception unit 212 is scanned and a direction 703 in which the printing medium is conveyed. From the plurality of light-receiving devices 701 arrayed at the light reception unit 212, the adjustment unit 209 (see FIG. 2) can freely set light-receiving devices 701 to use for output. After the adjustment unit 209 (see FIG. 2) selects and sets a plurality of light-receiving devices 701, a sum of outputs from the selected light-receiving devices 701 is outputted. The more the light-receiving devices 701 are selected, the higher the light reception sensitivity, and the fewer the light-receiving devices 701 are selected, the lower the light reception sensitivity. In this way, the adjustment unit 209 (see FIG. 2) can adjust the light reception sensitivity by changing the number of light-receiving devices of the light reception unit 212.

In this way, the differential output is adjusted as follows: having a plurality of light receiving devices, obtaining a differential output from outputs from the plurality of light-receiving devices, and adjusting the light reception sensitivity of the light reception unit using the adjustment unit 209. A technique for detecting an edge portion of a medium with high accuracy can thus be provided.

### Second Embodiment

A second embodiment of the present invention is described below with reference to the drawings. Note that the basic configuration of the present embodiment is the same as that of the first embodiment, and therefore the following describes a configuration characteristic of the present embodiment.

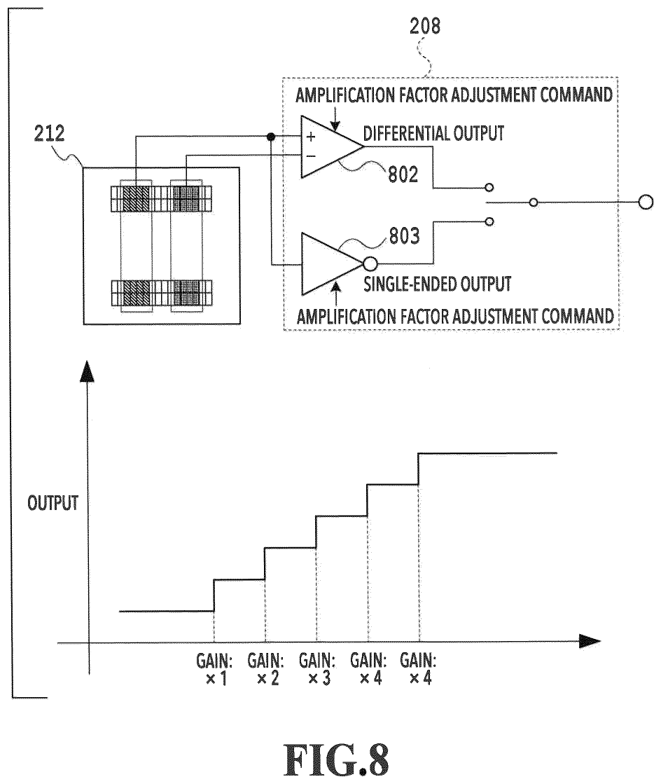

FIG. 8 is a diagram showing a method for adjusting the amplification factor of the output switch amplifier 208 of the light reception unit 212 in the present embodiment. As an example of sensitivity adjustment in the present embodiment, the following describes a method for adjusting the amplification factor of the output switch amplifier 208. In response to an instruction from the adjustment unit 209 (see FIG. 2), the output switch amplifier 208 can amplify a signal received from the light reception unit 212 and output an amplified signal.

Specifically, the output switch amplifier 208 can amplify a difference between voltages inputted from the light reception unit 212 to its input terminals. The amplification factor of the output switch amplifier 208 can be controlled by the adjustment unit 209.

In this way, the differential output is adjusted as follows: having a plurality of light reception units, obtaining a differential output from outputs from the plurality of light reception units, and adjusting the amplification factor of the output switch amplifier using the adjustment unit based on an adjustment amount derived from the differential output. A technique for detecting an edge portion of a medium with high accuracy can thus be provided.

### Third Embodiment

A third embodiment of the present invention is described below with reference to the drawings. Note that the basic configuration of the present embodiment is the same as that of the first embodiment, and therefore the following describes a configuration characteristic of the present embodiment.

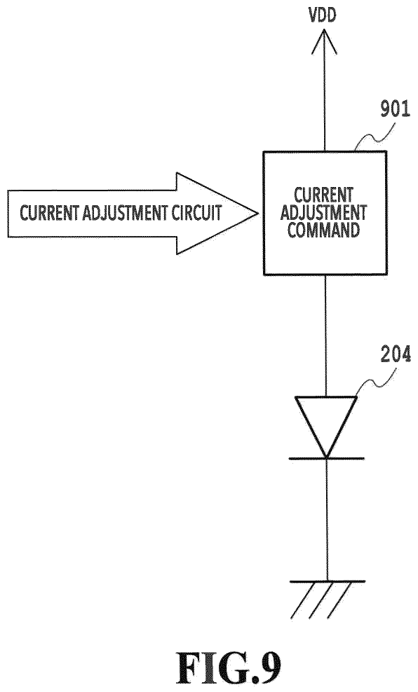

FIG. 9 is a diagram showing a method of current adjustment by a light emission amount adjustment circuit 901 of the light emission unit 204 (see FIG. 3A). As an example of sensitivity adjustment in the present embodiment, the following describes a method of current adjustment by the light emission amount adjustment circuit 901 of the light emission unit 204. The light emission amount adjustment circuit 901 can adjust the amount of light emitted by the light emission unit 204 by supplying current to the light emission unit 204 in an amount adjusted as controlled by the adjustment unit 209.

In this way, the differential output is adjusted as follows: having a plurality of light reception units, obtaining a differential output from outputs from the plurality of light reception units, and adjusting the amount of light emitted by the light emission unit 204 using the adjustment unit. A technique for detecting an edge portion of a medium with high accuracy can thus be provided.

### Other Embodiments

The above embodiments describe an example where the light reception unit 212 is divided into three light reception units: the first light reception unit 205, the second light reception unit 206, and the third light reception unit 207. As a different embodiment, the following describes a mode where the light reception unit 212 is divided into two light reception units: a first light reception unit and a second light reception unit. First, a printing medium is detected in the single-ended mode using the second light reception unit, and the sensitivity adjustment is performed for the single ended output signal based on the detection result. After that, the sensitivity of the first light reception unit is adjusted based on the sensitivity adjustment of the second light reception unit, and the differential output between the first light reception unit and the second light reception unit is corrected.

In this way, the differential output may be corrected in a configuration where the detection unit is divided into two units: the first light reception unit and the second light reception unit.

Thus, the present disclosure provides a technique for detecting an edge portion of a medium with high accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-163983, filed Sep. 20, 2024, which is hereby incorporated by reference herein in its entirety.

What is claimed is:

1. An edge portion detection method for detecting an edge portion of a sheet in terms of a width direction of the sheet using a detection unit provided at a carriage movable in the width direction, wherein
the detection unit has a light emission unit, a light reception unit including a first light reception unit including a plurality of light-receiving devices configured to receive light emitted from the light emission unit and then reflected and a second light reception unit disposed at a position away from the first light reception unit in the width direction and including a plurality of light-receiving devices configured to receive light emitted from the light emission unit and then reflected, and a differential amplification circuit unit configured to amplify a difference between an output signal from the first light reception unit and an output signal from the second light reception unit, and
the method comprises:
an adjustment step of adjusting a differential output from the differential amplification circuit unit,
an obtainment step of, while moving the carriage, obtaining the differential output from the differential amplification circuit unit adjusted in the adjustment step; and
a detection step of detecting an edge portion of the sheet based on a change in the differential output relative to a position of the carriage obtained in the obtainment step.

2. The edge portion detection method according to claim 1, wherein
the adjustment step adjusts the differential output from the differential amplification circuit unit by changing a number of light-receiving devices to use as the first light reception unit and a number of light-receiving devices to use as the second light reception unit among the plurality of light-receiving devices of the light reception unit.

3. The edge portion detection method according to claim 1, wherein
the adjustment step adjusts an amplification factor of the differential amplification circuit unit.

4. The edge portion detection method according to claim 1, wherein the adjustment step adjusts an amount of light emitted by the light emission unit.

5. The edge portion detection method according to claim 1, further comprising:
a second obtainment step of, while moving the carriage, obtaining an output signal from a third light reception unit including a plurality of light-receiving devices configured to receive light emitted by the light emission unit and then reflected; and
a derivation step of deriving a position of the edge portion based on the output signal from the third light reception unit obtained in the second obtainment step, wherein
the adjustment step adjusts the differential output based on the position of the edge portion derived in the derivation step.

6. The edge portion detection method according to claim 5, wherein
the third light reception unit includes different ones of the plurality of light receiving devices of the light reception unit from those of the first light reception unit and those of the second light reception unit.

7. The edge portion detection method according to claim 5, wherein
the third light reception unit includes same ones of the plurality of light-receiving devices of the light reception unit as those of the first light reception unit or those of the second light reception unit.

8. The edge portion detection method according to claim 1, further comprising a step of printing an image on the sheet by ejecting a liquid from a print unit carried by the carriage while moving the carriage based on information on the edge portion of the sheet detected in the detection step.

9. The edge portion detection method according to claim 1, wherein density detection is performed using a density sensor carried by the carriage.

10. The edge portion detection method according to claim 1, wherein
as the edge portion of the sheet, the detection step detects a middle point between a position where the differential output exceeds a predetermined threshold and a position where the differential output falls below the predetermined threshold.

11. An edge portion detection method employed by a liquid ejection apparatus including
a conveyance unit configured to convey a printing medium,
a moving unit configured to move a carriage in a scan direction intersecting with a conveyance direction in which the printing medium is conveyed by the conveyance unit, and
a detection unit provided at an end portion of the carriage in terms of the scan direction and having a light emission unit configured to apply light to the printing medium, a light reception unit having a plurality of light-receiving devices configured to receive light reflected by the printing medium, and an amplification circuit unit configured to amplify an output signal from the light reception unit, and
a control unit having an adjustment unit configured to adjust an output signal from the detection unit, the controlling unit being configured to control the detection unit, the method comprising:
a first adjustment step in which, in a first operation mode of the amplification circuit unit, a first light reception unit of the light reception unit receives light reflected by the printing medium conveyed by the conveyance unit, and the adjustment unit makes an adjustment on an output signal from the detection unit;
a switch step in which the control unit switches the first operation mode of the amplification circuit unit to a second operation mode different from the first operation mode;
a second adjustment step in which, in the second operation mode, the adjustment unit adjusts an output signal from the detection unit in an event where a second light reception unit of the light reception unit different from the first light reception unit receives light reflected by the printing medium based on the adjustment made in the first adjustment step; and
an edge portion detection step in which, in the second operation mode, an edge portion of the printing medium is detected by an output signal from the detection unit adjusted in the second adjustment step.

12. A liquid ejection apparatus comprising:
a carriage carrying a liquid ejection head and movable in a width direction of a sheet and a detection unit provided at the carriage, wherein
the detection unit has a light emission unit, a light reception unit including a first light reception unit including a plurality of light-receiving devices configured to receive light emitted from the light emission unit and then reflected and a second light reception unit disposed at a position away from the first light reception unit in the width direction and including a plurality of light-receiving devices configured to receive light emitted from the light emission unit and then reflected, and a differential amplification circuit unit configured to amplify a difference between an output signal from the first light reception unit and an output signal from the second light reception unit, and
the liquid ejection apparatus further comprises an adjustment unit configured to adjust the differential output from the differential amplification circuit unit.

13. The liquid ejection apparatus according to claim 12, further comprising:
an obtainment unit configured to, while moving the carriage, obtain the differential output from the differential amplification circuit unit adjusted by the adjustment unit and
a detection unit configured to detect an edge portion of the sheet based on a change in the differential output relative to a position of the carriage obtained by the obtainment unit.

14. The liquid ejection apparatus according to claim 12, wherein
the adjustment unit adjusts the differential output from the differential amplification circuit unit by changing a number of light-receiving devices to use as the first light reception unit and a number of light-receiving devices to use as the second light reception unit among the plurality of light-receiving devices of the light reception unit.

15. The liquid ejection apparatus according to claim 12, wherein
the adjustment unit adjusts an amplification factor of the differential amplification circuit unit.

16. The liquid ejection apparatus according to claim 12, wherein the adjustment unit adjusts an amount of light emitted by the light emission unit.

17. The liquid ejection apparatus according to claim 12, further comprising a conveyance unit configured to convey the sheet in a conveyance direction intersecting with the width direction, wherein
based on information on an edge portion of the sheet detected by the detection unit, an image is printed on the sheet by alternate execution of a print and scan operation and a conveyance operation by the conveyance unit, the print and scan operation being printing an image on the sheet by ejecting a liquid from the liquid ejection head while moving the carriage.
